(19) United States
(12) Patent Application Publication
(10) Pub. No.: US 2006/0070067 A1
(43) Pub. Date: Mar. 30, 2006

(54) Method of using scavenger grids in a network of virtualized computers

(75) Inventor: James C. Lowery, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 10/860,109

(22) Filed: Jun. 3, 2004

(51) Int. Cl. G06F 9/46

(52) U.S. Cl. 718/100

(57) ABSTRACT

A method of using scavenger grids in a network of virtual computers is disclosed. In one aspect, the present disclosure teaches a method of processing data using scavenger grids in a distributed computing network using virtualized computers including assigning a task to at least one virtual machine hosted via a virtualization client maintained on an information handling system. The method further includes binding an operating system and an application to the at least one virtual machine to perform the task based on the assigned task. The method further includes performing the task via the at least one virtual machine during idle processor cycles in the information handling system.

### TECHNICAL FIELD

The present disclosure relates generally to information handling systems and, more particularly, to a method of using scavenger grids in a virtualized computer network.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems employ a variety of problem-solving techniques to perform large complex computing jobs. One such technique includes the use of scavenger computing grids used on a distributed computing network, also known as a divide-and-conquer technique. As such, the scavenger grids technique divides the large complex computing jobs into several tasks. These tasks are then assigned to various computers operating in a dispersed geographic computer network that perform the task during idle processor cycles.

For example, the Search for ExtraTerrestrial Intelligence (SETI) Institute has initiated a program that leverages the idle time of desktop computers across the Internet to process radio telescope observations for signs of intelligent extraterrestrial life. In doing so, client software from SETI must be installed on a participant's machine. When an idle processor period is detected, the client software requests observations from a central computer, processes the observations, and then returns a result.

Unfortunately, the use of a scavenger grid system in an information handling system used in an enterprise system has proven to be difficult. Because scavenger grid systems employ a homogeneous operating system and specific-program application, it is difficult to create a generic scavenger client that can be used for a variety of business problems in the enterprise system. The generic scavenger client would have to be deployed across several computer systems operating on a distributed network in which an operating system already exists.

### SUMMARY

Thus, a need has arisen for a method of implementing scavenger grids across a distributed network of potentially different (heterogeneous) information handling systems. In one example embodiment, a mechanism exist to overcome the differences in the individual systems, so that they appear to be identical to the scavenger grid software.

In accordance with teachings of the present disclosure, in some embodiments, the present disclosure teaches a method of processing data using scavenger grids in a network of virtualized computers. This method includes augmenting each of the participating information handling systems in the network with a virtualization client. The virtualization client normalizes the characteristics of each information handling systems so that they appear to possess identical components, configurations, and capabilities. One of these is the capability to execute software, including but not limited to an operating system and attendant applications. Therefore, the method further includes installing or binding an operating system and an application on the virtualization client to perform an assigned task. The method further includes performing the task via the virtualization client during idle processor cycles in the information handling system.

In other embodiments, a system of using idle computer cycles in a virtualization client over a distributed network includes an information handling system maintaining a virtualization client that hosts at least one virtual machine. The system further includes a central server communicatively coupled to the information handling system via a network. The central server assigns a task stored in a virtual disk file to at least one virtual machine. The virtual disk file further includes an operating system and application-specific program that operably runs on at least one virtual machine to perform the task during idle computer cycles of the information handling system.

Important technical advantages of certain embodiments of the present invention include an operating system able to execute on virtualized hardwarevirtualization across information handling systems in a widely distributed enterprise network to support a distributed computing infrastructure that leverages idle processor cycles. For example, an operating system may execute on any physical hardward due to the normalization provided by the virtualization client. As such, the “guest” operating systems can be different from the host operating system and other guest operating system executing on other virtualization clients on the same physical hardware. Thus, end virtual machine or virtualization client “sees” a standard virtualized hardware.

All, some, or none of these technical advantages may be present in various embodiments of the present invention. Other technical advantages will be apparent to one skilled in the art from the following figures, descriptions, and claims.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram showing an information handling system, according to teachings of the present disclosure;

FIG. 2 is a block diagram of a scavenger grid using a distributed enterprise network, according to teachings of the present disclosure; and

FIG. 3 is a flow chart of using a scavenger grid in a distributed network, according to teachings of the present disclosure.

### DETAILED DESCRIPTION

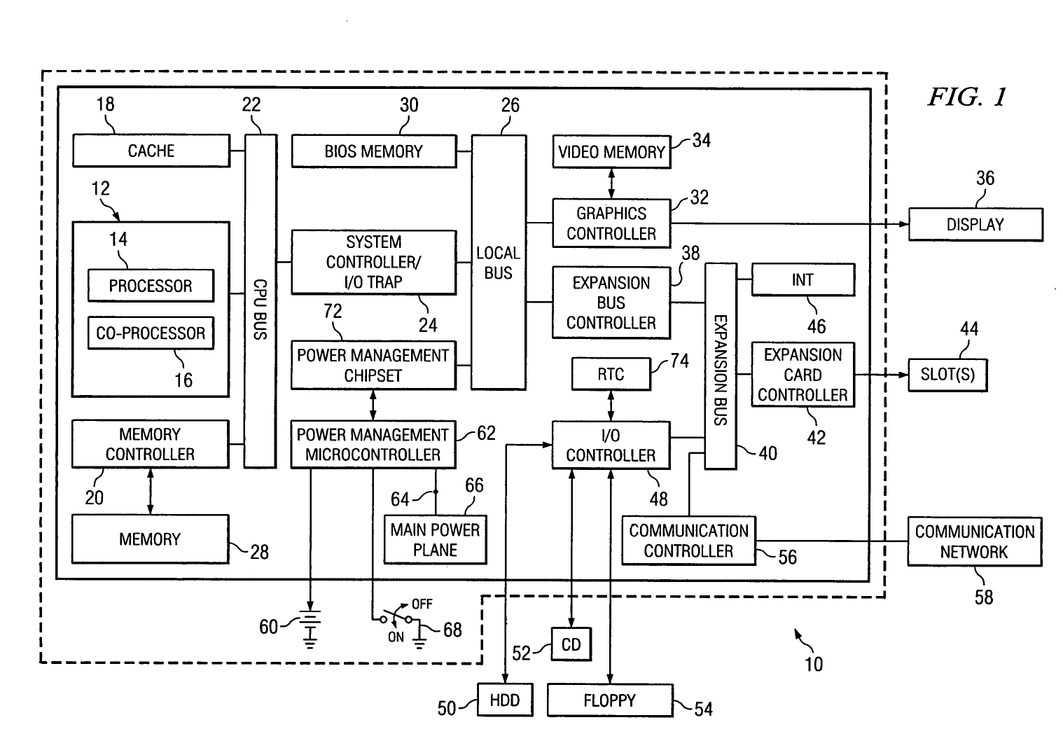

Preferred embodiments and their advantages are best understood by reference to FIGS. 1 through 3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a block diagram of information handling system 10 is shown, according to teachings of the present disclosure. Information handling system 10 or computer system preferably includes at least one microprocessor or central processing unit (CPU) 12. CPU 12 may include processor 14 for handling integer operations and coprocessor 16 for handling floating point operations. CPU 12 is preferably coupled to cache 18 and memory controller 20 via CPU bus 22. System controller I/O trap 24 preferably couples CPU bus 22 to local bus 26 and may be generally characterized as part of a system controller.

Main memory 28 of dynamic random access memory (DRAM) modules is preferably coupled to CPU bus 22 by a memory controller 20. Main memory 28 may be divided into one or more areas such as system management mode (SMM) memory area (not expressly shown).

Basic input/output system (BIOS) memory 30 is also preferably coupled to local bus 26. FLASH memory or other nonvolatile memory may be used as BIOS memory 30. A BIOS program (not expressly shown) is typically stored in BIOS memory 30. The BIOS program preferably includes software which facilitates interaction with and between information handling system 10 devices such as a keyboard (not expressly shown), a mouse (not expressly shown), or one or more I/O devices. BIOS memory 30 may also store system code (note expressly shown) operable to control a plurality of basic information handling system 10 operations.

Graphics controller 32 is preferably coupled to local bus 26 and to video memory 34. Video memory 34 is preferably operable to store information to be displayed on one or more display panels 36. Display panel 36 may be an active matrix or passive matrix liquid crystal display (LCD), a cathode ray tube (CRT) display or other display technology. In selected applications, uses or instances, graphics controller 32 may also be coupled to an integrated display, such as in a portable information handling system implementation.

Bus interface controller or expansion bus controller 38 preferably couples local bus 26 to expansion bus 40. In one embodiment, expansion bus 40 may be configured as an Industry Standard Architecture (“ISA”) bus. Other buses, for example, a Peripheral Component Interconnect (“PCI”) bus, may also be used.

In certain information handling system embodiments, expansion card controller 42 may also be included and is preferably coupled to expansion bus 40 as shown. Expansion card controller 42 is preferably coupled to a plurality of information handling system expansion slots 44. Expansion slots 44 may be configured to receive one or more computer components such as an expansion card (e.g., modems, fax cards, communications cards, and other input/output (I/O) devices).

Interrupt request generator 46 is also preferably coupled to expansion bus 40. Interrupt request generator 46 is preferably operable to issue an interrupt service request over a predetermined interrupt request line in response to receipt of a request to issue interrupt instruction from CPU 12.

I/O controller 48, often referred to as a super I/O controller, is also preferably coupled to expansion bus 40. I/O controller 48 preferably interfaces to an integrated drive electronics (IDE) hard drive device (HDD) 50, CD-ROM (compact disk-read only memory) drive 52 and/or a floppy disk drive (FDD) 54. Other disk drive devices (not expressly shown) which may be interfaced to the I/O controller include a removable hard drive, a zip drive, a CD-RW (compact disk-read/write) drive, and a CD-DVD (compact disk—digital versatile disk) drive.

Communication controller 56 is preferably provided and enables information handling system 10 to communicate with communication network 58, e.g., an Ethernet network. Communication network 58 may include a local area network (LAN), wide area network (WAN), Internet, Intranet, wireless broadband or the like. Communication controller 56 may be employed to form a network interface for communicating with other information handling systems (not expressly shown) coupled to communication network 58.

As illustrated, information handling system 10 preferably includes power supply 60, which provides power to the many components and/or devices that form information handling system 10. Power supply 60 may be a rechargeable battery, such as a nickel metal hydride (“NiMH”) or lithium ion battery, when information handling system 10 is embodied as a portable or notebook computer, an A/C (alternating current) power source, an uninterruptible power supply (UPS) or other power source.

Power supply 60 is preferably coupled to power management microcontroller 62. Power management microcontroller 62 preferably controls the distribution of power from power supply 60. More specifically, power management microcontroller 62 preferably includes power output 64 coupled to main power plane 66 which may supply power to CPU 12 as well as other information handling system components. Power management microcontroller 62 may also be coupled to a power plane (not expressly shown) operable to supply power to an integrated panel display (not expressly shown), as well as to additional power delivery planes preferably included in information handling system 10.

Power management microcontroller 62 preferably monitors a charge level of an attached battery or UPS to determine when and when not to charge the battery or UPS. Power management microcontroller 62 is preferably also coupled to main power switch 68, which the user may actuate to turn information handling system 10 on and off. While power management microcontroller 62 powers down one or more portions or components of information handling system 10, e.g., CPU 12, display 36, or HDD 50, etc., when not in use to conserve power, power management microcontroller 62 itself is preferably substantially always coupled to a source of power, preferably power supply 60.

Computer system, a type of information handling system 10, may also include power management chip set 72. Power management chip set 72 is preferably coupled to CPU 12 via local bus 26 so that power management chip set 72 may receive power management and control commands from CPU 12. Power management chip set 72 is preferably connected to a plurality of individual power planes operable to supply power to respective components of information handling system 10, e.g., HDD 50, FDD 54, etc. In this manner, power management chip set 72 preferably acts under the direction of CPU 12 to control the power supplied to the various power planes and components of a system.

Real-time clock (RTC) 74 may also be coupled to I/O controller 48 and power management chip set 72. Inclusion of RTC 74 permits timed events or alarms to be transmitted to power management chip set 72. Real-time clock 74 may be programmed to generate an alarm signal at a predetermined time as well as to perform other operations.

Using communications network 58, information handling system 10 may connect with other information handling systems to form another type of information handling system such as distributed enterprise network 80 (shown below in more detail).

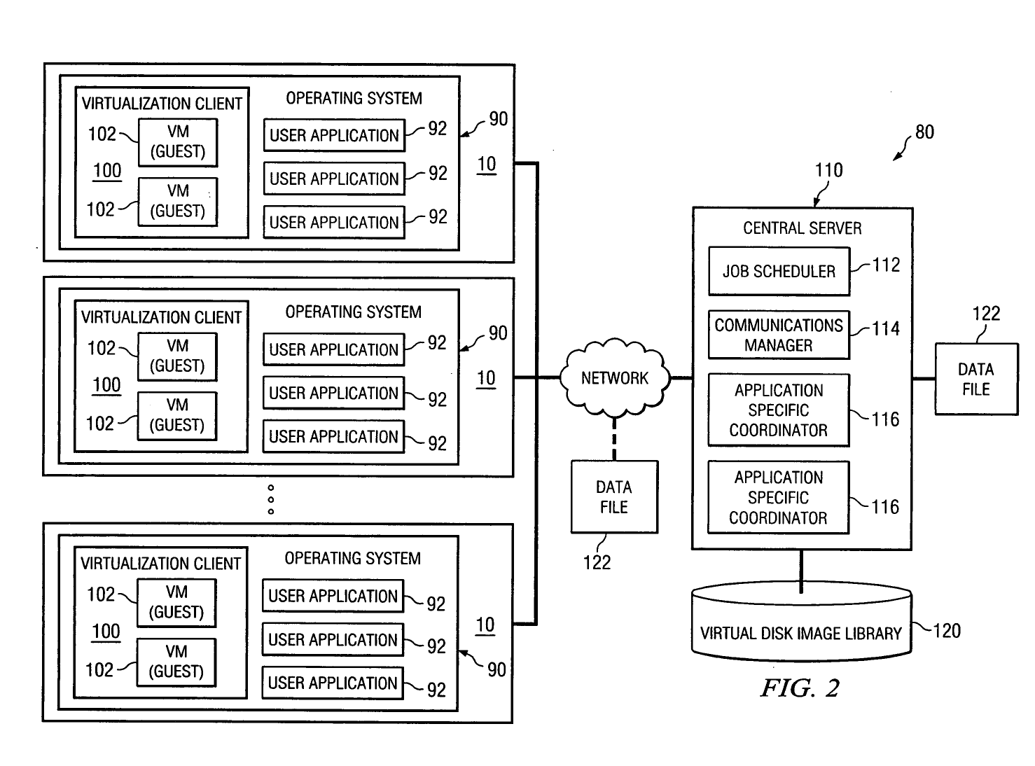

FIG. 2 is a block diagram of a scavenger grid using distributed enterprise network 80. Distributed enterprise network 80 is one type of information handling system typically consisting of a plurality of information handling systems 10 such as desktop computer systems that are interconnected via a network such as an intranet or Internet.

Generally, information handling system 10 as a part of distributed enterprise network 80 include host operating system (OS) 90 that runs a variety of user applications 92. Host OS 90 may also host virtualization client 100 including virtual machines 102. Virtualization client 100 allows for network 80 to employ a scavenger computing grid or a scavenger grid.

Scavenger grids employed on distributed enterprise network 80 typically include the installation of virtualization client 100 on each of information handling system 10 connected to network 80. Virtualization client 100 allows for the hosting of virtual machines 102 or guests such that virtualization client provides the logic to participate in the scavenger grid. Virtual machines 102 mimic generic computer hardware, which allows for the concurrent execution of operating systems commonly referred to as a guest OS that may be different from host OS 90. Additionally, the guest OS may even differ among virtual machines 102 hosted on the same information handling system 10.

Virtualization client 100 creates virtual machines 102 that “see” or perceive a standard virtualized hardware such that the virtualized hardware is identical for all virtual machines 102 regardless of respective hosting information handling system 10. Virtual machines 102 are usually created as a virtual disk that in reality is usually a large disk file managed by host OS 90.

Given the standardization or generic-nature of the virtualized hardware, virtual machines 102 may be moved or relocated between information handling systems 10. Typically, virtual machine 102 is moved to the new location by copying or saving the virtual disk at the new location.

Creating virtual machines allow for distributed enterprise network 80 to scavenge or leverage idle computing cycles from information handling systems 10 connected to network 80. By scavenging idle processing time, any workload can be distributed across network 80 to virtual machines 102 hosted on information handling systems 10. Additionally, by using virtualization client 100 to create virtual machines 102, host OS 90 and the guest OS 102 remain isolated from each other. This isolation aids in maintaining the integrity of host OS 90. In managing the scavenger grid, network 80 typically includes central server 110.

Central server 110 may include job scheduler 112 and communications manager 114 for coordination and monitoring of the scavenger grid and associated workload. Communications manager 114 generally communicates with each virtualization client 100 to determine idle processor cycle times such as availability of the host processor. During communications with virtualization client 100, communications manager 114 may update or maintain a host availability database to indicate the availability for task assignment to each virtual machine 102 participating in the scavenger grid.

Based on the database or other indicator, job scheduler 112 assigns part of a job or a task to a new or existing but available virtual machine 102, to be hosted by some virtualization client 100. In some instances, the assignment of tasks is based on the computing resources of information handling system 10 hosting the particular virtual machine 102. By assigning the tasks, job scheduler 112 maintains the flow of the workload on network 80.

Because the workload of network 80 may include a multitude of projects, job scheduler 112 may receive a virtual disk file from one or more application specific coordinators 116. Application specific coordinators 116 manage a specific job or project. Typically, each application specific coordinator 116 partitions or divides the job into several components or tasks. These tasks are maintained in application specific coordinator until assigned by job scheduler 112. Because each job may vary between application specific coordinators 116, the virtual disk file, including the task, generally includes an operating system and application-specific program(s) to perform the task.

Having bundled the operating system (guest OS), the application-specific program and task into one virtual disk file, job scheduler 112 can utilize communication manager 114 to either transmit the virtual disk file to the assigned virtual machine 102, or direct assigned virtual machine 102 to access the virtual disk file directly over the computer network using any suitable remote storage access method from another location, such as the virtual disk image library 120. This process is called “binding.” Virtual machine 102 may bind the guest OS and application-specific program during idle computer cycles. Once bound, virtual machine 102 will perform the task by executing the guest OS and application-specific program during idle computer cycles and prepare a result to return to central server 110.

Virtual disk image library 120 is a library of different operating systems and application-specific programs. In some embodiments, virtual disk image library 120 provides a specific virtual disk file that includes the operating system and application-specific program to application-specific coordinator 116 such that application specific coordinator 116 supplies the task before transmission of the virtual disk file to virtual machine 102. Typically, virtual disk image library 120 maintains an operating system and application-specific program for each job or problem to be solved by virtual machine 102.

Upon completion of the task, the respective virtual machine 102 transmits the results to application-specific coordinator 116 via communications manager 114. Application-specific coordinator 116 may compile the partial results from the various virtual machines 102 until the job or project is complete.

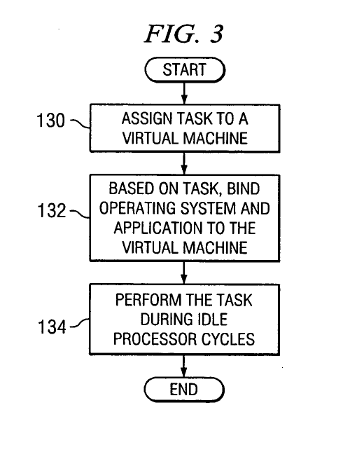

FIG. 3 is a flow chart of using a scavenger grid in distributed enterprise network 80. At block 130, a task is assigned to virtual machine 102. Typically, the task is created based on a partitioning of a job or project in application specific coordinator 116 located in central server 110. Generally, the task is included in a virtual disk file that includes an operating system and application-specific program. Typically, job scheduler 112 assigns the task based on availability of virtual machine 102 and the computing resources of the hosting information handling system 10. In some embodiments, an availability file database maintains a list of the available virtual machines 102 and the respective computing resources of the hosting information handling system 10. Virtual disk file is sent from application specific coordinator 116 via communications manager 114 to virtual machine 102, or virtual machine 102 is instructed to access the virtual disk file directly over the network from the virtual image library 120. Regardless of the binding method, virtual machine 102 processes the assigned task during idle processor cycles. Typically, the actions required to complete the binding of this software or programs to the virtual machine 102 are performed during idle processor cycles. Similarly, the execution of the application-specific program to perform the task is accomplished during idle processor cycles at block 134. However, in some embodiments, information handling system 10 may control the binding and execution of the operating system, application-specific program and task using management controls. For example, information handling system 10 may forcible claim a portion of the system's resources (e.g., setting resource access periods using administration privileges).

Typically, the virtual disk file includes all of the information needed to perform the task. However, in some instances, the task may require data from another source such as data file 122. Although data files 122 may be included in the virtual disk file via application specific coordinator 116, data files 122 are typically accessed from a storage location residing on network 80, most likely within in central server 110. Alternatively, data files 122 may be accessed via the Internet on remote servers or storage system.

Following completion of the task, the result is returned to central server 110 to build a solution to the job or project. Usually, application specific coordinator 116 receives the results and builds a result file until the job is complete.

Although the disclosed embodiments have been described in detail, it should be understood that various changes, substitutions and alterations can be made to the embodiments without departing from their spirit and scope.

What is claimed is:

1. A method of processing data using scavenger grids in a distributed network of virtualized computers, comprising:
assigning a task to at least one virtual machine hosted via a virtualization client maintained on an information handling system;
based on the assigned task, binding an operating system and an application to the at least one virtual machine to perform the task; and
performing the task via the at least one virtual machine during idle processor cycles in the information handling system.

2. The method of claim 1, further comprising, upon completion of the task, returning a result to a central server.

3. The method of claim 2, further comprising, upon completion of the task, updating a host availability database stored in a central file server operable to indicate the availability for task assignment.

4. The method of claim 1, wherein the task comprises a first task selected from a plurality of tasks that collectively perform a job.

5. The method of claim 4, further comprising combining a first result returned from the first task with other returned results to create a combined result for the job.

6. The method of claim 1, assigning the task based on computing resources available to the at least one virtual machine.

7. The method of claim 1, further comprising claiming a portion of system resources on the information handling system to perform the task.

8. The method of claim 1, further comprising retrieving data to perform the task via the network;

9. The method of claim 1, further comprising monitoring the information handling system to determine idle periods for performing the task assigned to the at least one virtual machine.

10. A system of using idle computer cycles through a virtualization client over a distributed network, comprising:
an information handling system maintaining a virtualization client that hosts at least one virtual machine;
a central server communicatively coupled to the information handling system via a network, the central server operable to assign a task stored in a virtual disk file to the at least one virtual machine; and
the virtual disk file further including an operating system and application-specific program that operably runs on the at least one virtual machine to perform the task during idle computer cycles of the information handling system.

11. The system of claim 10, wherein the central server further comprises a host availability database operable to determine the available status of the at least one virtual machine such that the virtual disk file is assigned.

12. The system of claim 11, wherein the central server further comprises a communications manager communicatively coupled to the network, the communications manager operable to maintain the host availability database via communications with the at least one virtual machine.

13. The system of claim 11, wherein the host availability database includes computing resources of the information handling system.

14. The system of claim 11, wherein the central server further comprises a job scheduler operable to assign the task to the at least one virtual machine based on the available host database.

15. The system of claim 14, wherein the job scheduler operably selects the at least one virtual machine based on computing resources of the information handling system.

16. The system of claim 10, further comprising a virtual disk image library communicatively coupled to the central server the virtual disk image library operable to store a plurality of operating systems and application programs, whereby each operating system and application program operably runs a respective task.

17. The system of claim 16, further comprising the virtual disk image library communicatively couples to the virtual machines on the distributed computing network.

18. The system of claim 10, wherein the central server further comprises a plurality of application specific coordinators operable to create a plurality of tasks that collectively solve a problem such that each task is assigned to one or more virtual machines.

19. An information handling system comprising:
a processor;
a memory coupled to the processor;
a communication controller communicatively coupling the processor and the memory to a distributed network;
a virtualization client communicatively coupled to the processor, the memory and the network;
the virtualization client operable to monitor the activity of the processor for idle computer cycles;
the virtualization client operable to host one or more virtual machines; and
each virtual machine operably creating a standard virtualized hardware in the information handling system such that an operating system and application specific program runs on the virtual machine, wherein the operating system and application specific program are part of a virtual disk file received via the network that performs a task during the idle computing cycles of the information handling system.

20. The information handling system of claim 19, further comprising a host operating system operable to maintain the visualization client.

21. The information handling system of claim 19, further comprising one or more user applications operable to run independently of the virtual machine.
